(19) United States
(12) Patent Application Publication
(10) Pub. No.: US 2011/0133583 A1
(43) Pub. Date: Jun. 9, 2011

(54) VIBRATING SCREEN AND MOTOR, MOTOR GROUP

(75) Inventors: Guozhen Zhao, Beijing (CN); Minghong Zhang, Beijing (CN); Deqi Pan, Beijing (CN)

(73) Assignee: BEIJING JISHENGLONG TECHNOLOGY CO. LTD, Beijing (CN)

(21) Appl. No.: 13/056,868

(22) PCT Filed: Aug. 7, 2008
(86) PCT No.: PCT/CN08/71913

§ 371 Date: Jan. 31, 2011

(51) Int. Cl. H02K 7/06

(52) U.S. Cl. 310/81

(57) ABSTRACT

A vibrating screen. The vibrating screen includes a vibrator, a screen box and a base. The vibrator includes at least a motor and an eccentric block coupled thereto. Each motor has a main motor shaft (2, 2A, 2B). A rotor winding (12) and a stator winding (11) are mounted at one end of the shaft (2). Another rotor winding (14) and stator winding (13) or a counterweight (5, 500) which is equal to them in weight are mounted at the other end of the shaft (2).

### FIELD OF THE INVENTION

The invention relates to a field of a vibrator, more particular to a vibrator, as well as a motor and a motor group applied in a vibrating screen.

### BACKGROUND OF THE INVENTION

With the development of the self-synchronizing technology, various self-synchronizing vibrating screens are basically designed such that the vibrating motor is directly involved in vibration.

The self-synchronizing vibrating screen includes a vibrator, a screen box and a base. The screen box is supported on the base via vibration-isolation rubber-compound springs. The vibrator includes a vibrating motor and an eccentric block.

When the vibrator employs the vibrating motor that is directly involved in vibration, there are high requirements for the mass and technical conditions of the vibrating motor, especially to the vibrator for providing a large vibrating force. The larger the vibrating force to be provided by the vibrator is, the larger the mass of the vibrator is. However, the larger the mass of the vibrator is, the higher the strength of the support member of the vibrator is required.

The conventional long motor has a motor winding at the centre thereof. Since the vibrating force of the vibrating screen is extremely large, it requires that the housing of the long motor has large strength to bear the large force. Therefore, it is necessary to thicken the housing, which increases the weight of the vibrator.

However, the desired vibrating screen demands that the vibrator provides a larger vibrating force while having a lighter mass. This contradiction prevents the development of the vibrating screen and vibrator.

### SUMMARY OF THE INVENTION

The embodiments of the present invention provide a vibrating screen and a motor, which are used to solve the contradiction between the provision of a larger vibrating force and the control of the mass of the vibrator.

In one aspect, the embodiment of the invention provides a vibrating screen including a vibrator, a screen box and a base. The vibrator includes at least one motor and an eccentric block installed to the motor.

Each motor includes a main motor shaft, a rotor winding installed on at least one end of the main motor shaft and a stator winding installed outside the rotor winding.

The main motor shaft is installed to the screen box by bearings and bearing seats or flanges prefabricated at both ends of the motor.

Preferably, the rotor windings and the stator windings installed outside the rotor windings are installed at both sides of the main motor shaft, and the main motor shaft includes a predetermined distance between the two rotor windings.

Preferably, the rotor winding and the stator winding installed outside the rotor winding are installed at one end of the main motor shaft, and a counterweight for balancing the main motor shaft is installed at the other end of the main motor shaft, and the main motor shaft includes a predetermined distance between the rotor winding and the counterweight.

Preferably, the vibrator includes two motors which are disposed in parallel with each other.

The invention further provides a vibrating screen including a vibrator, a screen box and a base. The vibrator includes at least one motor group and an eccentric block installed to the motor group.

Each motor group comprises two sub motors, a transmission shaft and shaft couplings coupling the two the sub motors and the transmission shaft.

Or, each motor group comprises one sub motor, a counterweight having the same weight as the sub motor, a transmission shaft and shaft couplings coupling the sub motor, the counterweight and the transmission shaft.

Preferably, the vibrator includes two motor groups which are disposed in parallel with each other.

The invention also provides a motor including a main motor shaft, a rotor winding installed on at least one end of the main motor shaft and a stator winding installed outside the rotor winding.

Preferably, the rotor winding and the stator winding installed outside the rotor winding are installed at one end of the main motor shaft, and a counterweight for balancing the main motor shaft is installed at the other end of the main motor shaft, and the main motor shaft includes a predetermined distance between the rotor winding and the counterweight.

The invention further provides a motor group including two sub motor, a transmission shaft and shaft couplings coupling the two sub motors and the transmission shaft.

The invention also provides another motor group including one sub motor, a counterweight having the same weight as the sub motor, a transmission shaft and shaft couplings coupling the sub motor, the counterweight and the transmission shaft.

The motor according to the embodiment of the invention includes a main motor shaft, a rotor winding installed on at least one end of the main motor shaft and a stator winding installed outside the rotor winding. The length of the main motor shaft may be determined according to actual installation demands by installing the motor(s) at one or both ends of the main motor shaft. Thus, compared with the case that the motor is installed at the centre of the main motor shaft, the torque caused by the weight of the motor according to the invention having the same mass with respect to the fixed installation point where the main motor shaft is fixed to an apparatus (for example, the side plate of the screen box) is smaller, so as to solve the contradiction that the mass of the vibrating system is increased when the motor provides a larger vibrating force.

### BRIEF DESCRIPTION OF THE DRAWINGS

FIG. 1 is a structural view of a first embodiment of the motor according to the invention;

FIG. 2 is a structural view of a second embodiment of the motor according to the invention;

FIG. 3 is a structural view of a third embodiment of the motor according to the invention;

FIG. 4 is a structural view of a forth embodiment of the motor according to the invention;

FIG. 5 is a structural view of a first embodiment of the motor group according to the invention;

FIG. 6 is a structural view of a second embodiment of the motor group according to the invention;

FIG. 7 is a structural view of the vibrator according to the embodiments of the invention;

FIG. 8 is a structural view of a first embodiment of the vibrating screen according to the invention;

FIG. 9 is a top view of the vibrating screen shown in FIG. 8; and

FIG. 10 is a structural view of a second embodiment of the vibrating screen according to the invention.

### DETAILED DESCRIPTION

The objects, technical solutions and advantages of the invention will become more apparent from the following detailed description of the invention with reference to the embodiments and the drawings. It should be noted that the specific embodiments described herein are only used to explain the invention, but not intended to limit the invention.

In an aspect of the invention, a motor is provided to solve the contradiction between the provision of a large vibrating force and the increase of the mass of the vibrating system.

Referring to FIG. 1, FIG. 1 is a structural view of a first embodiment of the motor according to the invention.

The motor according to the first embodiment of the invention includes a main motor shaft 2 and two electromotors installed on the main motor shaft 2. The first electromotor includes a first rotor winding 12 installed on one end of the main motor shaft 2 and a first stator winding 11 installed outside and matched with the first rotor winding 12.

The second electromotor includes a second rotor winding 14 installed on the other end of the main motor shaft 2 and a second stator winding 13 installed outside and matched with the second rotor winding 14.

The first electromotor and the second electromotor may adopt the same or different type of electromotor. If the first electromotor and the second electromotor adopt different type of electromotor, the actual weights of the first electromotor and the second electromotor should be counterweighted (or adjusted) in order to ensure the balance between the electromotors at both ends of the main motor shaft 2.

There is a predetermined distance between the first electromotor and the second electromotor. The predetermined distance may be determined according to the actual conditions for installing the motor. A housing is installed outside of the first electromotor and the second electromotor. The portion of the housing located between the first electromotor and the second electromotor only plays a role of coupling, and thus only needs a strength which may support its own weight. Therefore, the weight of the housing and thus the motor may be effectively reduced.

When the motor according to the first embodiment of the invention is used in an apparatus, the main motor shaft 2 is installed to side plates of the apparatus by way of bearings 3 and bearing seats or flanges prefabricated at the ends of the motor.

The motor according to the first embodiment of the invention includes the main motor shaft 2 and the two electromotors installed on the main motor shaft 2. The length of the main motor shaft 2 may be determined depending on actual installation requirements by installing two electromotors on both ends of the main motor shaft 2, respectively. Thus, compared with the motor in which an electromotor is installed at the centre of the main motor shaft 2, the motor according to the first embodiment of the invention for providing the same vibrating force has a lighter weight. The motor according to the first embodiment of the invention may relieve the contradiction that the motor is increased in its mass when it provides a larger vibrating force.

The motor according to the first embodiment of the invention may control the first electromotor and the second electromotor to be in an operating state simultaneously according to use requirements, so as to provide a dual power. Alternatively, the motor according to the first embodiment of the invention may selectively control one of the electromotors to be in the operating state, and the other electromotor to be in a stop state, so as to provide a single power.

For the motor according to the embodiment of the invention, two electromotors may be provided at two ends of the main motor shaft, respectively. Any of the electromotors may be actuated according to different working conditions. For example, when the motor is used in a vibrating screen and one of the electromotors being in failure state is de-energized, the driven vibrating screen may continue to work by actuating the other electromotor.

If a larger driving force is desired according to working conditions, the two electromotors may be actuated simultaneously. When the motor is used in the vibrating screen, the processing ability of the vibrating screen may be increased.

For the motor according to the embodiment of the invention, two electromotors are designed to be located at two ends of the main motor shaft respectively, such that the gravity centre of the winding of the electromotor is close to the support point of the motor (for example, the side plates of the screen box in the vibrating screen to which the motor is installed). Compared with the motor in which the winding is located at the centre of the main motor shaft, the torque applied on the housing of the motor is greatly decreased, and thus strength of the housing may be reduced, thereby decreasing the weight of the housing. The motor according to the embodiment of the invention may better solve the contradiction between the increase of the power of the motor and the decrease of the mass of the motor.

The motor according to the first embodiment of the invention may selectively control the first electromotor or the second electromotor to be in the operating state. Thus, the first electromotor and the second electromotor may be alternately used, as long as it can meet the working demands, and thus the working life of the motor is prolonged. When one of the electromotors is in the failure state, the other electromotor may be independently operated, so as to effectively ensure the efficiency of the motor.

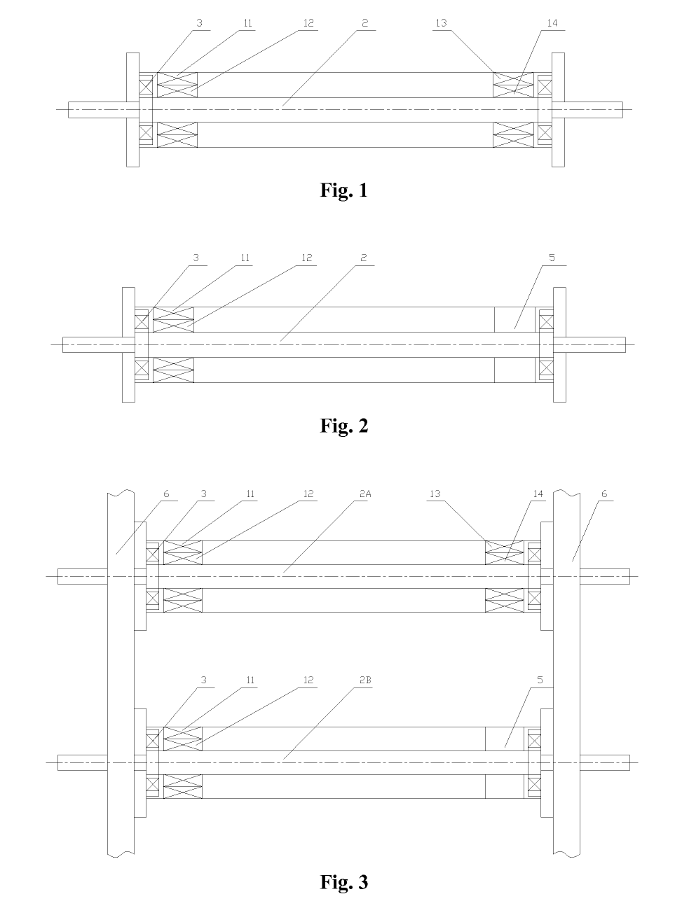

Referring to FIG. 2, FIG. 2 is a structural view of a second embodiment of the motor according to the invention.

The difference between the second embodiment and the first embodiment of the motor according to the invention lies in that the motor according to the second embodiment only includes one electromotor.

The motor according to the second embodiment of the invention includes a main motor shaft 2. The main motor shaft 2 is installed with a first rotor winding 12 and a first stator winding 11 located outside of the first rotor winding 12 at one end thereof, and installed with a counterweight for balancing the main motor shaft 2 at the other end thereof. There is a predetermined distance between the first rotor winding 12 and the counterweight 5 on the main motor shaft 2.

The motor according to the second embodiment of the invention includes the main motor shaft 2, the first rotor winding 12 installed at one end of the main motor shaft 2 and the first stator winding 11 installed outside of the first rotor winding 12. The length of the main motor shaft 2 may be determined according to actual installation requirement by installing the first electromotor at one end of the main motor shaft 2 and installing the counterweight 5 with the same mass as the first electromotor at the other end of the main motor shaft 2. The electromotor and the counterweight which are respectively located at both ends of the main motor shaft 2 have the same mass. Compared with the motor in which the electromotor is installed at the centre of the main motor shaft 2, in the motor according to embodiment of the invention, the torque caused by the weight at each side of the main motor shaft 2 with respect to the installation point where the main motor shaft 2 is fixed to an apparatus is smaller. In this way, the contradiction that the mass of the vibrating system is increased when the motor provides a larger vibrating force may be solved.

The motor according to the embodiment of the invention includes at least the first rotor winding 12 installed at one end of the main motor shaft 2 and the first stator winding 11 installed outside of the first rotor winding 12.

The motor according to the embodiment of the invention may be provided with eccentric blocks at both ends of the motor, so as to vibrate the motor.

Referring to FIG. 3, FIG. 3 is a structural view of a third embodiment of the motor according to the invention.

The difference between the third embodiment and the preceding embodiments of the motor according to the invention lies in that the motor according to the third embodiment includes two main motor shafts being parallel with each other, on each of which the electromotor (s) described in the first embodiment or the second embodiment may be installed.

The motor according to the third embodiment of the invention includes two main motor shafts being parallel with each other, i.e., the first main motor shaft 2A and the second main motor shaft 2B.

The first main motor shaft 2A may be installed with two electromotors of the motor according to the first embodiment of the invention.

The second main motor shaft 2B may be installed with one electromotor and one counterweight 5 of the motor according to the second embodiment of the invention.

The motor according to the third embodiment of the invention includes the first main motor shaft 2A and the second main motor shaft 2B which are parallel with each other. When the two electromotors installed on the first main motor shaft 2A and one electromotor installed on the second main motor shaft 2B are in the operating state simultaneously, a triple power may be provided.

The motor according to the third embodiment of the invention may provide a plurality of power cases according to the varied power requirements. This motor may control the first electromotor and the second electromotor on the first main motor shaft 2A and the first electromotor on the second main motor shaft 2B to be in the operating state or in the stop state.

Of cause, both the first main motor shaft 2A and the second main motor shaft 2B may installed with the two electromotors of the motor according to the first embodiment of the invention, or may installed with the electromotor and the counterweight 5 of the motor according to the second embodiment. When the two electromotors installed on the first main motor shaft 2A and the two electromotors installed on the second main motor shaft 2B are in the operating state simultaneously, a quadruple power may be provided. A user may selectively control one, two, three or all of the four electromotors to be in the operating state according to specific working conditions.

Referring to FIG. 4, FIG. 4 is a structural view of a forth embodiment of the motor according to the invention.

The difference between the forth embodiment and the third embodiment of the motor according to the invention lies in that both the first main motor shaft 2A and the second main motor shaft 2B of the motor according to the forth embodiment are installed with the two electromotors of the motor according to the first embodiment of the invention.

When the two electromotors installed on the first main motor shaft 2A and the two electromotors installed on the second main motor shaft 2B are in the operating state simultaneously, a quadruple power may be provided. A user may selectively control one, two, three or all of the four electromotors to be in the operating state according to specific working conditions.

The electromotors installed on the first main motor shaft 2A and the second main motor shaft 2B may have the same or different power.

If the electromotors installed on the first main motor shaft 2A and the second main motor shaft 2B have the different power, a plurality of power cases may be provided by selectively combining the different electromotors to work.

In another aspect of the invention, a motor group is provided to solve the contradiction that the mass of the vibrating system is increased when a larger vibrating force is provided.

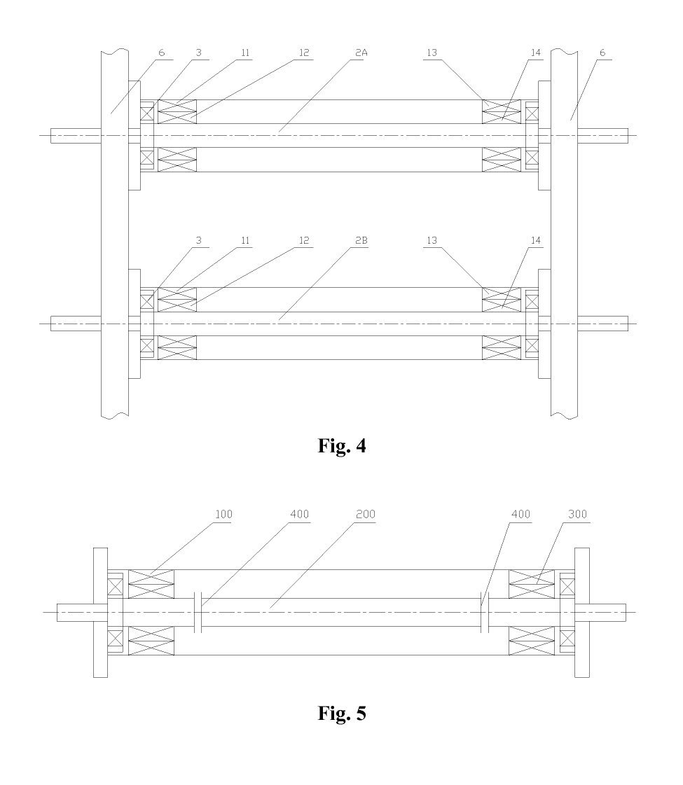

Referring to FIG. 5, FIG. 5 is a structural view of a first embodiment of the motor group according to the invention.

The motor group according to the first embodiment of the invention includes a transmission shaft 200 and two sub motors, i.e., a first sub motor 100 and a second sub motor 300.

The transmission shaft 200 is coupled to the first sub motor 100 and the second sub motor 300 by shaft couplings 400 respectively, and it is ensured that the transmission shaft 200 is rotated at the same rotation speed as the first sub motor 100 and the second sub motor 300.

The first sub motor 100 and the second sub motor 300 may be implemented by short motors. The length of the transmission shaft 200 may be selected according to specific installation requirements.

The shaft coupling may be selected from a spline shaft type, a gimbal type or a pin type according to the requirements.

A housing may be provided to protect the transmission shaft 200 and the shaft couplings 400 between the first sub motor 100 and the second sub motor 300, so as to connect the two sub motors together.

The motor group according to the first embodiment of the invention includes the two sub motors and the transmission shaft 200. The length of the transmission shaft 200 may be determined depending on actual installation requirements. Since the motor group is provided with two sub motors at both ends of the transmission shaft 200 respectively, compared with the case that one motor is installed at the centre of the transmission shaft, the torque caused by the gravity of the sub motors with the same mass with respect to the fixing installation point is smaller. The motor group according to the first embodiment of the invention may solve the contradiction that the mass of the vibrating system is increased when the motor provides a larger vibrating force.

The motor group according to the first embodiment of the invention may control the first sub motor and the second sub motor to be in the operating state simultaneously, so as to provide a dual power. Alternatively, the motor group according to the first embodiment of the invention may selectively control one of the sub motors to be in the operating state, and the other one to be in a standby state, so as to provide a single power.

The motor group according to the first embodiment of the invention may selectively control the first sub motor or the second sub motor to be in the operating state. Thus, the first sub motor and the second sub motor may be alternately used, as long as it can meet the working demands, and thus the working life of the motor group is prolonged. When one of the sub motors is failure, the other one may be independently operated, so as to effectively ensure the working efficiency of the motor group.

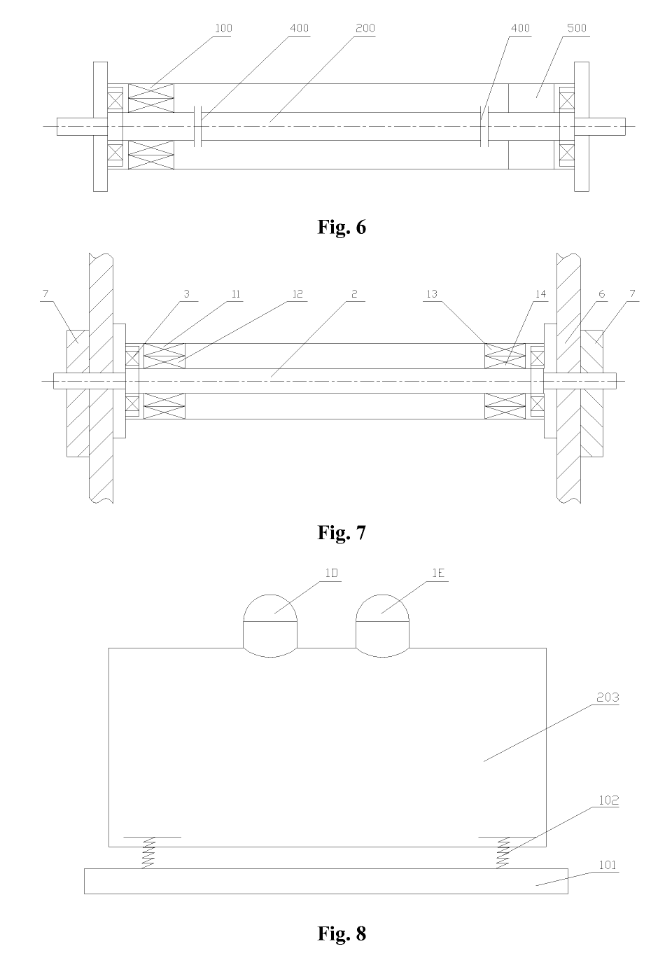

Referring to FIG. 6, FIG. 6 is a structural view of a second embodiment of the motor group according to the invention.

The difference between the second embodiment and the first embodiment of the motor group according to the invention lies in that the motor group according to the second embodiment does not include the second sub motor 300.

The motor group according to the second embodiment of the invention includes the first sub motor 100, a counterweight 500 having the same weight as the first sub motor 100, the transmission shaft 200 and the shaft couplings 400 which connect the first sub motor 100, the counterweight 500 to the transmission shaft 200 respectively.

In the motor group according to the second embodiment of the invention, the length of the transmission shaft 200 may be determined according to actual installation requirements. The balance is achieved between the first sub motor connected to the transmission shaft 200 and the counterweight 500 connected to the transmission shaft 200 and having the same mass as the first sub motor. The torque caused by the gravity at each side of the transmission shaft 200 with respect to the fixing installation point is smaller than the case that the motor is installed at the centre of the transmission shaft 200. Thus, the contradiction that the mass of the vibrating system is increased when the motor provides a larger vibrating force may be solved.

In a further aspect of the invention, a vibrator is provided to solve the contradiction that the mass of the vibrator is increased when a larger vibrating force is provided.

The vibrator according to the embodiment of the invention includes at least one motor or motor group described above, and the eccentric block installed to the motor or motor group.

Referring to FIG. 7, FIG. 7 is a structural view of the vibrator according to the embodiment of the invention.

The vibrator according to the embodiment of the invention includes at least one motor and the eccentric block 7 installed on the motor.

The motor may include the main motor shaft 2 and two electromotors installed on the main motor shaft 2. The first electromotor includes the first rotor winding 12 installed at one end of the main motor shaft 2 and the first stator winding 11 installed outside and matched with the first rotor winding 12.

The second electromotor may include the second rotor winding 14 installed on the other end of the main motor shaft 2 and the second stator winding 13 installed outside and matched with the second rotor winding 14.

The first electromotor and the second electromotor may adopt the same or different type of electromotor. If the first electromotor and the second electromotor adopt different type of electromotor, the actual weights of the first electromotor and the second electromotor should be counterweighted in order to balance the forces applied to both ends of the main motor shaft 2.

There is a predetermined distance between the first electromotor and the second electromotor. The predetermined distance may be determined according to the actual conditions for installing the motor.

The main motor shaft 2 is installed to side plates 6 of the apparatus by way of bearings 3 and bearing seats or flanges prefabricated at the ends of the motor, and the eccentric blocks 7 are disposed near the side plates 6 respectively. Each eccentric block 7 is provided with a through hole fitted with the main motor shaft 2.

The vibrator according to the embodiment of the invention may include two motors and eccentric blocks installed to the motors. Each of the motors includes the main motor shaft, the rotor winding installed on at least one end of the main motor shaft and the stator winding installed outside the rotor winding. The at least one rotor winding in the motor is in the operating state.

In an else aspect of the invention, a vibrating screen is provided to solve the contradiction that the mass of the vibrating screen is increased when a larger vibrating force is provided.

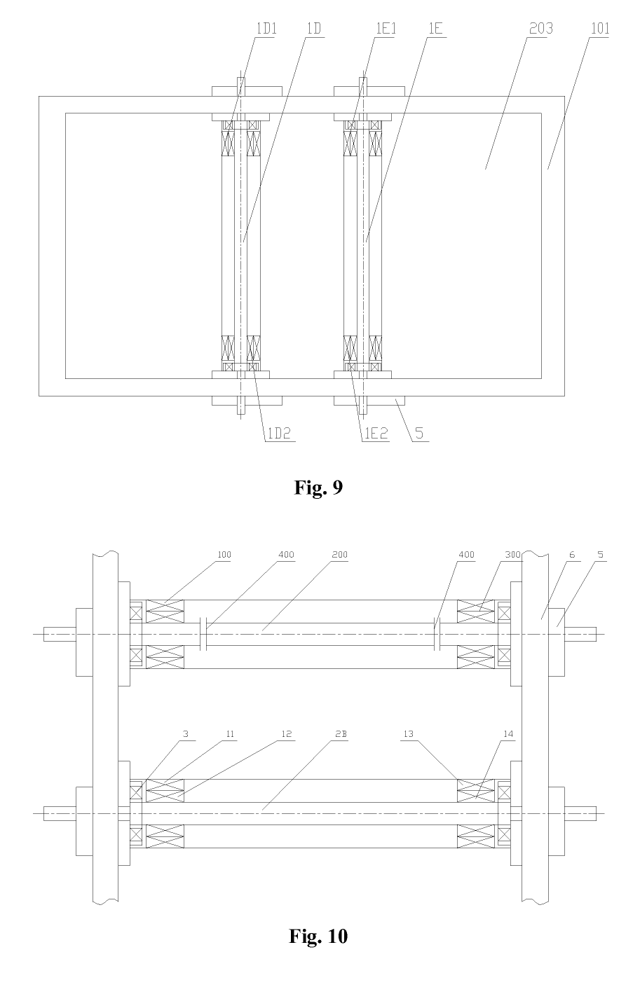

Referring to FIGS. 8 and 9, FIG. 8 is a structural view of a first embodiment of the vibrating screen according to the invention; and FIG. 9 is a top view of the vibrating screen shown in FIG. 8.

The vibrating screen according to the first embodiment of the invention includes two motors being disposed in parallel with each other and eccentric blocks installed to both ends of the motors. The motor may be in any form described above.

The vibrating screen according to the first embodiment of the invention includes two motors, i.e., the first motor 1D and the second motor 1E. The first motor 1D and the second motor 1E are placed in parallel with each other.

Both the first motor 1D and the second motor 1E include the main motor shaft and the electromotor installed on at least one end of the main motor shaft. The electromotor includes the rotor winding and the stator winding installed outside the rotor winding.

The first motor 1D includes the electromotors 1D1 and 1D2, the second motor 1E includes the electromotors 1E1 and 1E2.

The main motor shafts are installed and fixed to a screen box 203 by way of bearings and bearing seats or flanges prefabricated at the ends of the motors.

In general, only the electromotors at the same side of the two motors are actuated to allow the vibrating screen to come into a normal operating state. The electromotors which are not working at the other side of the two motors may serve as the balance counterweights or standby electromotors when the vibrating screen is operated.

When one of the electromotors is failure, the electromotor may be de-energized immediately and serves as a counterweight. The electromotor opposite to the failed electromotor is actuated, so as to allow the vibrating screen to continuously work.

Since there is the standby electromotor(s), a sudden stop in drilling may be avoided, which decreases the waste of the drilling fluid (also referred as slurry) due to the failure of the vibrating screen. Besides, since there is the standby electromotor(s), the working life of the vibrating screen may be effectively prolonged.

The vibrating screen according to the first embodiment of the invention may achieve a number of vibrating models. The powers of the first motor 1D and the second motor 1E may be different. The two electromotors 1D1, 1D2 of the first motor 1D may adopt the electromotors with the same power. The two electromotors 1E1, 1E2 of the second motor 1E may adopt the electromotors with the same power.

The power of the two electromotors 1D1, 1D2 of the first motor 1D may be larger than that of the two electromotors 1E1, 1E2 of the second motor 1E.

When the vibrating screen works in a normal state, it is only necessary to actuate the electromotors at the same end of the first motor 1D and the second motor 1E, which can meet the processing requirements of conventional slurry.

When the drilling is performed in a state that the slurry has a high viscosity and a large amount of discharge, four electromotors of the first motor 1D and the second motor 1E may be actuated in the following combination modes in order to meet the requirements of processing slurry:

the first mode: 1D1, 1D2 and 1E1;

the second mode: 1D1, 1D2 and 1E2;

the third mode: 1E1, 1E2 and 1D1;

the forth mode: 1E1, 1E2 and 1D2; and

the fifth mode: 1D1, 1D2, 1E1 and 1E2.

In the above five combination modes, the different powers of the vibrating motors (the above-mentioned first and second motor) are added, and the vibrating track of the vibrating screen is changed in the maximum horizontal acceleration, the vertical acceleration, the maximum amplitude and the horizontal displacement, so as to achieve the vibrating tracks of various vibrating models of the vibrating screen.

Referring to FIG. 10, FIG. 10 is a structural view of a second embodiment of the vibrating screen according to the invention.

The difference between the second embodiment and the first embodiment of the vibrating screen of the invention lies in that the vibrator of the vibrating screen according to the second embodiment includes two motors or two motor groups which are placed in parallel with each other. The motor and motor group may be in any form described above.

The vibrating screen according to the embodiment of the invention may also include two motor groups being placed in parallel with each other. The motor group may be in any form described above.

While the preferred embodiments of the present invention have been described above, it is not intended to limit the present invention. Any variation, equivalent and improvement made within the spirit and principle of the present invention should be deemed to fall into the protection scope of the present invention.

1. A vibrating screen comprising a vibrator, a screen box and a base, wherein the vibrator comprises at least one motor and an eccentric block installed to the motor,
wherein each motor comprises a main motor shaft, a rotor winding installed on at least one end of the main motor shaft and a stator winding installed outside the rotor winding, and
wherein the main motor shaft is installed to the screen box by bearings and bearing seats or flanges prefabricated at both ends of the motor.

2. The vibrating screen according to claim 1, wherein the rotor windings and the stator windings installed outside the rotor windings are installed at both sides of the main motor shaft, and the main motor shaft includes a predetermined distance between the two rotor windings.

3. The vibrating screen according to claim 1, wherein the rotor winding and the stator winding installed outside the rotor winding are installed at one end of the main motor shaft, and a counterweight for balancing the main motor shaft is installed at the other end of the main motor shaft, and the main motor shaft includes a predetermined distance between the rotor winding and the counterweight.

4. The vibrating screen according to claim 1, wherein the vibrator comprises two motors which are disposed in parallel with each other.

5. A vibrating screen comprising a vibrator, a screen box and a base, wherein the vibrator comprising at least one motor group and an eccentric block installed to the motor group,
wherein each motor group comprises two sub motors, a transmission shaft and shaft couplings coupling the two the sub motors and the transmission shaft,
or, each motor group comprises one sub motor, a counterweight having the same weight as the sub motor, a transmission shaft and shaft couplings coupling the sub motor, the counterweight and the transmission shaft.

6. The vibrating screen according to claim 5, wherein the vibrator comprises two motor groups which are disposed in parallel with each other.

7. A motor comprising a main motor shaft, a rotor winding installed on at least one end of the main motor shaft and a stator winding installed outside the rotor winding.

8. The motor according to claim 7, wherein the rotor winding and the stator winding installed outside the rotor winding are installed at one end of the main motor shaft, and a counterweight for balancing the main motor shaft is installed at the other end of the main motor shaft, and the main motor shaft includes a predetermined distance between the rotor winding and the counterweight.

9. A motor group comprising two sub motors, a transmission shaft and shaft couplings coupling the two sub motors and the transmission shaft.

10. A motor group comprising one sub motor, a counterweight having the same weight as the sub motor, a transmission shaft and shaft couplings coupling the sub motor, the counterweight and the transmission shaft.

11. The vibrating screen according to claim 2, wherein the vibrator comprises two motors which are disposed in parallel with each other.

12. The vibrating screen according to claim 3, wherein the vibrator comprises two motors which are disposed in parallel with each other.
